(19) United States
(12) Patent Application Publication
(10) Pub. No.: US 2026/0067511 A1
(43) Pub. Date: Mar. 5, 2026

(54) TECHNIQUES FOR STREAMING LIVE MEDIA CONTENT WITH MEDIA EVENTS

(71) Applicant: NETFLIX, INC., Los Gatos, CA (US)

(72) Inventor: Mark WATSON, San Francisco, CA (US)

(21) Appl. No.: 19/074,137

(22) Filed: Mar. 7, 2025

Related U.S. Application Data
(60) Provisional application No. 63/691,153, filed on Sep. 5, 2024.

(51) Int. Cl. H04N 21/2187; H04N 21/84

(52) U.S. Cl. CPC H04N 21/2187; H04N 21/84

(57) ABSTRACT

In various embodiments, a method for streaming media content with media events comprises receiving, at a first time, a request for a manifest associated with media content for a live streaming event; generating the manifest based on the request, wherein the manifest includes one or more first media events that occur prior to the first time; transmitting, to a client application, the manifest and the media content for playback; and transmitting, to the client application, a media events track that includes one or more second media events that occur subsequent to the first time.

### CROSS-REFERENCE TO RELATED APPLICATIONS

This application claims priority benefit of the United States Provisional patent application titled “TECHNIQUES FOR STREAMING LIVE MEDIA CONTENT WITH EVENTS” filed on Sep. 5, 2024, and having Serial No. U.S. 63/691,153. The subject matter of this related application is hereby incorporated herein by reference.

### BACKGROUND

### Field of the Various Embodiments

The various embodiments relate generally to computer science and media streaming and, more specifically, to techniques for streaming live media content with media events.

### DESCRIPTION OF THE RELATED ART

Live streaming of media content is the process of continuously transmitting real-time media content over a network for playback by client applications. Supplemental content, such as advertisement breaks and program content (e.g., intro/outro credits, chapters, blackouts, and extensions), are sometimes streamed and played back along with the media content. To inform client applications of supplemental content, information about the supplemental content, such as transition points corresponding to the beginning and ending of the supplemental content, need to be delivered to the client applications in a timely and frame-accurate manner. Media events, which are indicators of the start and end splice points of supplemental content, can be included in a manifest that also includes information on the live stream media content in order to indicate where the supplemental content should be spliced into the media content segments.

One approach for transmitting information about media events to a client application is using a constantly updated manifest. Manifests traditionally include encoding information for media content, but manifests can also include media events that indicate timing information, such as start and end times, of supplemental content to be inserted into media content.

One drawback of using manifests to transmit media events is that the client application needs to repeatedly download updated manifests that include media events corresponding to the supplemental content that needs to be inserted into the media content being streamed. Repeatedly downloading manifests is computationally expensive, for both the client application that requests the manifests and the server that transmits the manifests. Repeatedly downloading manifests also consumes network bandwidth each time a manifest is downloaded.

Another drawback of using manifests to transmit media events is that different manifests need to be created for different client applications. Individually generating manifests for each client application can cause a scaling issue for the media streaming system because the number of manifests that need to be generated increases along with the number of client applications that stream media content.

As the foregoing illustrates, what is needed in the art are more effective techniques for delivering events for streaming media content.

### SUMMARY

One embodiment sets forth a computer-implemented method for streaming media content with media events. The method includes receiving, at a first time, a request for a manifest associated with media content for a live streaming event. The method further includes generating the manifest based on the request, where the manifest includes one or more first media events that occur prior to the first time. The method also includes transmitting, to a client application, the manifest and the media content for playback. Furthermore, the method includes transmitting, to the client application, a media events track that includes one or more second media events that occur subsequent to the first time.

At least one technical advantage of the disclosed techniques relative to the prior art is that, with the disclosed techniques, media events indicating start and end times of supplemental content can be accurately delivered without wasting network bandwidth and with built in scalability. In addition, by using a single manifest along with a media events track, the disclosed techniques do not require a client application to repeatedly download new/updated manifests to receive accurate information regarding upcoming or past media events and associated supplemental content. As a result, there is less complexity at the client applications, and streaming delays can also be avoided. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the manifest server of FIG. 1, according to various embodiments;

FIG. 3 is a more detailed illustration of a user device of FIG. 1, according to various embodiments;

FIG. 4 is more detailed illustration of the manifest server and live origin server of FIG. 1, according to various embodiments; and

FIG. 5 is a flow diagram of method steps for delivering media events, according to various embodiments.

### DETAILED DESCRIPTION

In the following description, numerous specific details are set forth to provide a more thorough understanding of the various embodiments. However, it will be apparent to one of skill in the art that the inventive concepts can be practiced without one or more of these specific details.

As described, one drawback of conventional approaches for transmitting information about media events to a client application, which utilizes a constantly updated manifest, is that the client application needs to repeatedly download the updated manifests. Repeatedly downloading updated manifests can be computationally expensive, for both the client application that requests the manifests and the server that transmits the manifests. Repeatedly downloading manifests also consumes network bandwidth each time a manifest is downloaded. Another drawback of using manifests to transmit media events is that different manifests may need to be created for different client applications. Individually generating manifests for each client application can cause a scaling issue for the media streaming system because the number of manifests that need to be generated increases along with the number of client applications that stream media content.

The disclosed techniques allow for live streaming of media content with media events. In some embodiments, a media content source sends (1) static metadata associated with media content, such as live streamed media content, and supplemental content embedded therein to a static metadata server; and (2) segments of the media content to an encoder. The encoder encodes the segments to generate encoded audio, video, and text streams, and the encoder further generates a media events track. The encoder sends the encoded segments of the media content, and the media events track to a packager. The packager extracts dynamic metadata for each media event associated with the supplemental content embedded in the encoded segments and the media events track. The packager sends the dynamic metadata to a dynamic metadata server. The dynamic metadata server makes the events available to a manifest server that includes a manifest application. The manifest application generates a manifest based on the static metadata, the dynamic metadata, and the media events track. The manifest application sends the manifest to a client application. The live origin server sends one or more media content streams, and the media events track to a client application. The media content stream(s) and the media events track can also be cached using one or more content distribution networks (CDNs) that include a CDN steering server. During playback of the media content based on the media content stream(s), the client application uses the manifest to determine media events and associated information regarding current and past supplemental content. In addition, the media events track is used to transmit, to the client application, media events associated with future supplemental content that are not specified in the manifest.

At least one technical advantage of the disclosed techniques relative to the prior art is that, with the disclosed techniques, media events can be accurately delivered without wasting network bandwidth and with built in scalability. In addition, by using a single manifest along with a media events track, the disclosed techniques do not require a client application to repeatedly download new/updated manifests to receive accurate media events regarding upcoming or past supplemental content. As a result, there is less complexity at the client applications, and streaming delays can also be avoided.

### System Overview

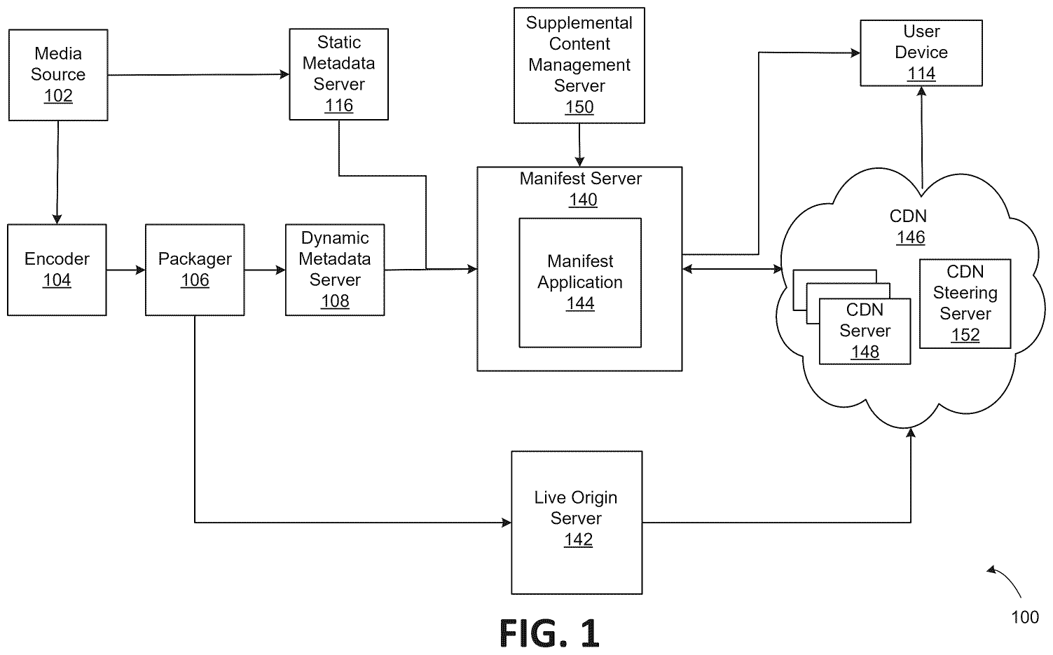

FIG. 1 illustrates a block diagram of a computer-based system 100 configured to implement one or more aspects of the various embodiments. As shown, system 100 includes, without limitation, a media source 102, an encoder 104, a packager 106, a dynamic metadata server 108, a static metadata server 116, a supplemental content management server 150, a manifest server 140, a live origin server 142, one or more user devices 114, and a CDN146 that includes one or more CDN servers 148 and a CDN steering server 152. Each of the various aspects of system 100 can be connected to each other in any technically feasible manner, such as via the Internet, a local area network (LAN), a wireless network, etc.

Media source 102 is a source of digital media data. For example, media source 102 could be a transmission truck connected to one or more cameras and one or more microphones that capture a live streaming event, such as a live concert or sports game. As another example, media source 102 could be a network operations center to which a transmission truck sends an uncompressed media data signal. In some embodiments, media source 102 can be a system component that is located at a premises external to the premises of the other aspects of system 100, such as a transmission truck located near where a live media feed is being captured. Although shown as directly communicating with encoder 104 for simplicity, in some embodiments, media source 102 can communicate with a media connector that interfaces with media source 102 to receive transmitted media data, terminate the transmission, and extract video streams from the transmitted data. In such cases, the media connector can enable the exchange of various types of media, such as audio, video, and text, by supporting different protocols and data formats, and the media connector can incorporate hardware and/or software to manage data translation, signal conversion, or protocol adaptation, ensuring appropriate routing of media content across diverse environments.

In some embodiments, media source 102 is configured to embed supplemental content, discussed in greater detail below, into the media content associated with a live streaming event during real-time recording of the media content. For example, software at the transmission truck or network operations center, described above, can provide a user interface (UI) for users to manually trigger supplemental content and/or can support automatically scheduled supplemental content. Media source 102 is also configured to send the media content to encoder 104. In addition, media source 102 is configured to send static metadata to static metadata server 116 and encoder 104. Static metadata can be determined by media source 102 in advance of embedding the supplemental content into the live stream of media content. Static metadata can include downloadable information associated with the media content, such as one or more audio tracks, one or more video tracks, and a media events track. For example, the static metadata can include the bitrate, language, and other information associated with the tracks. Although described herein primarily with respect to static metadata being received from media source 102 as a reference example, in some embodiment, static data about the tracks can also or alternatively be received from the encoder 104 and/or the packager 106.

Encoder 104 is specialized software and/or hardware designed to encode audio, video, and text data. Encoding is the process of converting raw digital content into a suitable format for storage, transmission, and/or display. Encoder 104 can process various types of content, such as audio, video, and/or text, by applying compression algorithms and encoding schemes to transform raw data content into one or more optimized, standardized formats. Encoder 104 can support multiple encoding standards and codecs to accommodate different content types and delivery platforms. For example, encoder 104 can perform video transcoding and generate different audio/video bit rates and segment encoded video to small chunks for distribution. Encoder 104 is configured to receive media content with embedded events and associated static metadata from media source 102. In some embodiments, encoder 104 extracts the embedded events from the media content and converts the received data into a moving picture experts group 4 part 14 (MPEG-4 Part 14 or MP4) file format. Encoder 104 is also configured to determine dynamic metadata for one or more media events, each associated with supplemental content, that is extracted from the media content. Dynamic metadata can be determined when the live stream of the media content begins and can include, for each of any number of media events, a start time, media presentation duration, presentation time offset, start segment number, segment uniform resource locator (URL) templates, media timescale, and segment duration, each associated with supplemental content. Encoder 104 is configured to send the dynamic metadata, the encoded media content, and the media events track to packager 106 for packaging, as discussed in greater detail below.

As used herein, “supplemental content” includes content not included in the main media content program/stream, such as advertisement breaks and other program content, such as intro/outro credits, chapters, blackouts, and extensions. As used herein, “media event” and “event” are used interchangeably to refer to data regarding timing and frame-accurate information about transitional points (i.e., splice points) of the supplemental content that is embedded in media content associated with a live streaming program. Media events can indicate a period in the media content stream that either contains supplement content or is intended to be replaced by supplemental content. The action of inserting, removing, or replacing the supplements content into or from the media content stream can be conducted by other means. Media events can align with specific frames in a video stream. Media events can be defined in any suitable format, such as the Digital Program Insertion Cueing Message (SCTE-35), which is the core signaling standard for advertising and program/distribution control of content for content providers/distributors. SCTE-35 signals can be used to identify supplemental content breaks, such as advertisement breaks, program content, such as intro/outro credits, chapters, blackouts, and extensions when a live stream, such a stream for a sporting game, continues after the allotted time. SCTE-35 supports the splicing of media content streams for the purpose of media content insertion, which includes advertisements and other forms of supplemental content. SCTE-35 defines an in-stream messaging mechanism to signal information related to splicing and insertion opportunities. SCTE-35 is configured to carry notifications of upcoming insertion or splicing points and other timing information in the transport stream. The following table describes four example events that can be used in the techniques disclosed herein:

| | Point, | | |
|---|---|---|---|
| | timespan, | | |
| Event | or infinite | Purpose | SCTE-35 message |
| Program Start | Point | Indicates | time_signal( ) |
| | | the start of | splice_time( ) |
| | | the live | splice_descriptor( ) |
| | | program. | splice_descriptor_tag = 2 |
| | | | (segmentation_descriptor) |
| | | | ... |
| | | | segmentation_event_id = x |
| | | | segmentation_event_cancel_indicator = |
| | | | 0 |
| | | | ... |
| | | | program_segmentation_flag = 1 |
| | | | segmentation_duration_flag = 0 |
| | | | delivery_not_restricted_flag = 1 |
| | | | segmentation_upid_type = 0 |
| | | | segmentation_type_id = 0x10 (Program |
| | | | Start) |
| | | | segment_num = 1 |
| | | | segments_expected = 1 |
| Program End | Point | Indicates | time_signal( ) |
| | | the end of | splice_time( ) |
| | | the live | splice_descriptor( ) |
| | | program. | splice_descriptor_tag = 2 |
| | | | (segmentation_descriptor) |
| | | | ... |
| | | | segmentation_event_id = x |
| | | | segmentation_event_cancel_indicator = |
| | | | 0 |
| | | | ... |
| | | | program_segmentation_flag = 1 |
| | | | segmentation_duration_flag = 0 |
| | | | delivery_not_restricted_flag = 1 |
| | | | segmentation_upid_type = 0 |
| | | | segmentation_type_id = 0x11 (Program |
| | | | End) |
| | | | segment_num = 1 |
| | | | segments_expected = 1 |
| Ad Break | Timespan | Indicates | time_signal( ) |
| | | the time and | splice_time( ) |
| | | expected | splice_descriptor( ) |
| | | duration of | splice_descriptor_tag = 2 |
| | | an ad | (segmentation_descriptor) |
| | | break. | ... |
| | | | segmentation_event_id = x |
| | | | segmentation_event_cancel_indicator = |
| | | | 0 |
| | | | ... |
| | | | program_segmentation_flag = 1 |
| | | | segmentation_duration_flag = 1 |
| | | | segmentation_duration( ) |
| | | | delivery_not_restricted_flag = 1 |
| | | | segmentation_upid_type = 0 |
| | | | segmentation_type_id = 0x34 |
| | | | (Placement Provider Opportunity Start) |
| | | | segment_num = 0 |
| | | | segments_expected = 0 |
| Ad Break Early | Point | Indicates | time_signal( ) |
| Termination | | the end time | splice_time( ) |
| | | of an ad | splice_descriptor( ) |
| | | break in the | splice_descriptor_tag = 2 |
| | | case of | (segmentation_descriptor) |
| | | early return | ... |
| | | (ad break | segmentation_event_id = x |
| | | ends early) | segmentation_event_cancel_indicator = |
| | | | 1 |

Regarding the SCTE-35 column in the above table, time_signal( ) commands are used to insert new content at a splice point at the splice_time( ) Furthermore, splice_descriptor( ) describes information related to the splice such as a segmentation_event_id. The segmentation_event_id can be a number used as identification for the specific media event. The segmentation_event_cancel_indicator in combination with the segmentation_event_id can be used to indicate that a specific media event should be canceled. For example, the Ad Break Early Termination media event in the table above is used to modify the duration of a previous stored Ad Break media event or remove the media event entirely if the associated supplement content has not occurred yet.

In some embodiments, media events data includes dynamic metadata and a set of media event records, as defined in the tables below: Media Events Metadata:

| | | Man- | |
|---|---|---|---|
| Data Element | Type | datory | Description |
| timescale | number | Yes | Timescale for the presentation |
| | | | time offset and the media events |
| | | | timestamps |
| eventBaseTime | number | Yes | This is the millisecond (ms) time |
| | | | from which event timestamps are |
| | | | measured. |
| mediaEventsCut- | number | Yes | The is the ms time beyond which |
| offTime | | | events are not included in the |
| | | | manifest. All events that occurred |
| | | | before this time can be included. |

### Media Event Record:

| Data | | Man- | |
|---|---|---|---|
| Element | Type | datory | Description |
| type | enum | Yes | One of {Program Start, Program End, Ad |
| | | | Break} |
| | | | When the event is delivered in a media |
| | | | events track, this is the |
| | | | segmentation_type_id from the SCTE-35 |
| | | | message. |
| | | | Ad Break and Ad Break Start are |
| | | | synonymous. |
| id | number | No | Mandatory for events that can be |
| | | | cancelled or modified, such as Ad Break. |
| | | | When the event is delivered in a media |
| | | | events track, this is the |
| | | | segmentation_event_id from the SCTE |
| | | | message (and not the ID from the |
| | | | EventMessageInstance boxes layer) |
| timestamp | number | Yes | The timestamp, in the timescale included |
| | | | in the metadata, of the event, or the start |
| | | | of the event. |
| | | | This is specified as an offset from the |
| | | | eventBaseTime. |
| | | | When the event is delivered in a media |
| | | | events track, this is the sum of the media |
| | | | events track sample Decode Time Stamp |
| | | | (DTS) (also equal to Composition Time |
| | | | Stamp (CTS) and Presentation Time) with |
| | | | the presentation_time_delta from the |
| | | | EMIB layer |
| duration | number | No | The duration of the event in the timescale |
| | | | included in the metadata. |
| | | | This is only needed when type = Ad Break |
| | | | When the event is delivered in a media |
| | | | events track, this is the event_duration |
| | | | field from the EMIB layer. |

The time periods spanned by media events can be non-overlapping in some embodiments. Encoder 104 is configured to support canceling or modification of media events. Encoder 104 is configured to remove or modify any canceled or modified media events on reception of a cancel or modify instruction from media source 102 (e.g., only one of the original media event or the cancelled/modified media event can exist at the same time). Alternatively, an End event may be sent to indicate early termination of supplemental content, for example for an Ad Break Start event may be paired with an Ad Break End event.

In some embodiments, the media events can have a separate timescale than the audio, video, text stream of media content associated with a live streaming event. In some embodiments, the media events can have the same timescale as the video track of the live stream. To derive the time of an event, the timestamp of a specific event can be converted to ms and added to the eventBaseTime. To identify the video frame associated with a specific event, the ms-rounded video frame timestamp can be compared with the ms-rounded event timestamp, or equivalently 1 ms can be added to the event timestamp and rounded down to the nearest video frame.

The media events track is a data track, such as an mp4 track, that describes supplemental content, each of which can begin during a given media content at a specific timestamp indicated by a media event, can have a duration from a start time to an end time, or can have an infinite or indefinite duration. Adaptive streaming with Dynamic Adaptive Streaming over HTTP (DASH) or Hypertext Transfer Protocol Live Streaming (HTTP Live Streaming or HLS) requires the content to be segments. Therefore, in some embodiments, the media events track is segmented for delivery similar to an audio, video, or text mp4 track. The same media event can correspond to one or more segments depending on the length of the media event. In some embodiments, the media events track describes media events by reference to an event message box (EMSG). In some embodiments, segments of a media events track can include a standard mp4 track structure indicating the timing, size and position of the media content (e.g., Track Run Box (trun)).

In some embodiments, segments of a media events track can include either one or more EventMessageInstance boxes (EMIB) or a single EventMessageEmptyBox (EMEB). In the media events track format, the presentation time and duration (if present) of the media event appear in explicit fields within the EMIB as well as within a SCTE-35 message data. Client applications can rely on the explicit fields in the EMIB and do not need to interpret the fields within the message data. In some embodiments, the only requirement for interpreting the SCTE-35 message data is to determine the event type and for event cancellation the ID and cancellation flag. In such cases, SCTE-35 events can be identified with the Uniform Resource Name (URN) urn:scte:scte35:2013:bin in the scheme_id_uri field of the EMIB. The value field can be empty and the message_data field can include the SCTE-35 message in binary form.

The media events history includes the media events metadata and the set of media events indicating the start and end times of supplemental content that have occurred prior to time T. The value of T is included in the dynamic metadata as mediaEventsCutoffTime.

A point event is a type of media event, such as a Program Start, that has a single timestamp but zero duration, can appear in a segment including the timestamp of a media event, and can appear in subsequent segments for a pre-defined period of seconds, such as 10 seconds, 20 seconds, 30 seconds, or a similar other predefined duration. The point event can appear in earlier segments if known earlier. The event_duration field of a point event can be set to zero, but the sample duration at the mp4 layer can be the pre-roll duration, or 1 tick if there is no pre-roll. A timespan event is associated with supplemental content, such as an advertisement break, that has a start timestamp and an end timestamp, and can appear in all segments whose timespan intersects with the event timespan.

Encoder 104 is configured to perform stream conditioning at the video frame indicated in the splice_time( ) field of each of the four messages defined above, and at the video frame indicated by the sum of splice_time( ) and break_duration( ) provided that no End event indicating the end of a media event is received before such a time. Stream conditioning is the adaptation of the media encoding to ensure that the video can be seamlessly spliced at the frame identified as a splice point. For a splice in point (transition into the live stream, e.g., end of an event), the frame must be an I-frame, which are frames encoded without reference to any other frame except for (parts of) the I-frame. For a splice out point (transition out of the live stream, e.g., start of an event), frames before the splice point in presentation time cannot have encodings that depend on frames after the splice point. To achieve the foregoing, encoder 104 converts the splice point frame (the first frame that is not rendered from the live stream at the splice) into an I-frame.

Packager 106 includes a publishing server (not shown) that can create, manage, and distribute digital content across a network. Packager 104 can manage the workflow for content updates, ensuring that content is properly prepared and formatted for dissemination. Packager 106 can include any software for content management, authentication, and distribution automation. Packager 106 can receive encoded media content, dynamic metadata, and the media events track from encoder 104. Packager 106 can package the received encoded media content, dynamic metadata, and the media events track using transmultiplexing. Transmultiplexing is the process of changing the container format of an audio or video file without modifying the original content. For example, packager 106 can receive encoded media content in the mp4 format from the encoder and convert the encoded media content into a distributable package for output according to a format such as the HLS format or the DASH format. Packager 106 can send the dynamic metadata to dynamic metadata server 108. Packager 106 can send the media content packages, and the media events track to live origin server 142. Packager 106 can be a separate entity or coupled to the encoder 104.

Dynamic metadata server 108 is configured to receive dynamic metadata of media events associated with supplemental content embedded in media content. In operation, dynamic metadata server 108 verifies the dynamic metadata of each event contains the mandatory data, as described in the tables above. Dynamic metadata server 108 is configured to make the media events available to any server device or application, such as manifest application 144, for use in creating manifests.

Static metadata server 116 is a server that is configured to receive static metadata associated with media content. The static metadata can include downloadable information associated with one or more tracks associated with the media content, such as a video track(s), audio track(s), and/or a media events track. In some embodiments, static metadata for video and/or audio tracks can include additional information associated with bitrate, language, and other relevant information. In some embodiments, static metadata for media events tracks can include information that denotes the existence of the track. Static metadata server 116 sends the static metadata to manifest server 140.

Supplemental content management server 150 is a server that is configured to receive one or more supplemental content plan requests from manifest server 140. A supplemental content plan request can include the positions and durations of media events. Supplemental content management server 150 is configured to determine a supplemental content plan that includes URLs for one or more supplemental content based on the information in the supplemental content plan request. Supplemental content management server 150 is configured to send the supplemental content plan to manifest server 140.

Live origin server 142 is a server device configured to transmit media content (e.g., video, audio, and/or media events track) associated with live streaming events to one or more user devices 114 via CDN 146. Live origin server 142 is considered the source of truth for the media content associated with live streaming events. In some embodiments, live origin server 142 can be one or more server devices included in and/or replaced with any type of virtual computing system, distributed computing system, and/or cloud computing environment, such as a public, private, or a hybrid cloud system along with other server devices, such as manifest server 140. In some embodiments, live origin server 142 is configured to receive a request for media content from user device 114 via CDN 146 if the media content requested is not currently cached at one or more CDN servers 148 associated with CDN 146. In response to the request for media content, live origin server 142 transmits the requested media content (e.g., video, audio, and/or media events track) to the user device 114. CDN 146 can also cache the requested media content at one or more CDN servers 148 for future transmission to one or more user devices 114.

In some embodiments, live origin server 142 can include a software application, such as a live origin application that is stored in memory of live origin server 142 and executes on one or more processors of live origin server 142. In some embodiments, live origin application is a separate server device included in and/or replaced with any type of virtual computing system, distributed computing system, and/or cloud computing environment, such as a public, private, or a hybrid cloud system. Live origin application is configured to receive and store various data associated with media content that live origin server 142 makes available. Illustratively, live origin application receives, for media content associated with each live streaming event that live origin application 142 makes available, one or more media content tracks (e.g., audio and/or video) and a media events track from packager 106.

Manifest server 140 is a server device configured to transmit one or more manifests associated with live streaming events to one or more user devices 114 based on one or more manifest requests. Illustratively, manifest server 140 includes, without limitation, a manifest application 144. In some embodiments, manifest server 140 can be included in and/or replaced with any type of virtual computing system, distributed computing system, and/or cloud computing environment, such as a public, private, or a hybrid cloud system along with other server devices, such as live origin server 142. Manifest server 140 is configured to receive one or more manifest requests from one or more user devices 114, static metadata from static metadata server 116, dynamic metadata from dynamic metadata server 108, and event plans from the supplemental content management server 150.

Manifest application 144 is a software application that is stored in memory of manifest server 140 and executes on one or more processors of manifest server 140. Manifest application 144 is configured to receive manifest requests. Furthermore, manifest application 144 is configured to generate and make available, for media content associated with a live streaming event, a manifest that specifies one or more video tracks, audio tracks, and/or timed text tracks, which permits a client application (e.g., a client application running in one of user devices 114) to download and play back any portion of the media title in accordance with a combination of the tracks specified in the manifest. In some embodiments, one of the tracks specified by the manifest is a media events track associated with the same media content. In addition, the manifest includes a data structure specifying the media events indicating the start and end times of supplemental content that have occurred so far in the media content (up to the latest media event received by the manifest server 140 from dynamic metadata server 108). For example, the data structure can indicate the media events up to a mediaEventsCutoffTime, which is the time (ms time) up to which the events have been received.

User devices 114 are electronic devices that individuals utilize to interact with digital content or services over a network. User devices 114 can include, but are not limited to, personal computers, laptops, smartphones, tablets, smart TVs, gaming consoles, and/or wearable devices such as smartphones with an application to stream media content. Client applications (not shown) running on user devices 114 can connect to and communicate with server device 140 or other network components to access, consume and manipulate content or engage in various digital activities, such as streaming media content. Client devices 112 can include processors, memory, communication interfaces, and user interfaces.

CDN steering server 152 is a server device that manages one or more CDNs servers 148 in CDN 146. CDN servers 148 are used to store and deliver media content to one or more user devices 114. CDN steering server 152 is configured to determine which CDN server within CDN servers 148 to use for delivery of media content. In some embodiments, when multiple CDNs are used, CDN steering server 152 can determine which CDN among the multiple CDNs to use for delivery of media content, and load-balancing mechanisms inside the CDN can select a particular CDN server. In some embodiments, the determination of which CDN servers within CDN servers 148 to use can be based on, without limitation, analyzing data from one or more user devices 114, CDN logs, network traffic load, and/or a steering manifest that describes which CDN server 148 should be used. CDN steering server 152 provides more control, flexibility, and near real-time responsiveness to requests from user devices due to the ability to dynamically switch between CDN servers 148 for delivery of media content. In some embodiments, CDN steering server 152 can determine to not use a CDN server within CDN servers 148 and request media content from live origin server 146 instead. Such determination can be based on CDN servers 148 not having previously or recently cached the requested media content. In some embodiments, CDN steering server 152 can also provide, to manifest server 140, information (e.g., URLs) about where media content tracks are stored in CDN 146. In such cases, manifest server 140 can generate manifests that include such media content tracks as well as associated URLs that client applications can access to download the media content tracks.

System 100 is shown herein for illustrative purposes only, and variations and modifications are possible without departing from the scope of the present disclosure. For example, the number and types of servers, and/or the number of user devices can be modified as desired. Further, the connection topology between the various units in FIG. 1 can be modified as desired. In some embodiments, any combination of the server(s) and/or user devices can be included in and/or replaced with any type of virtual computing system, distributed computing system, and/or cloud computing environment, such as a public, private, or a hybrid cloud system.

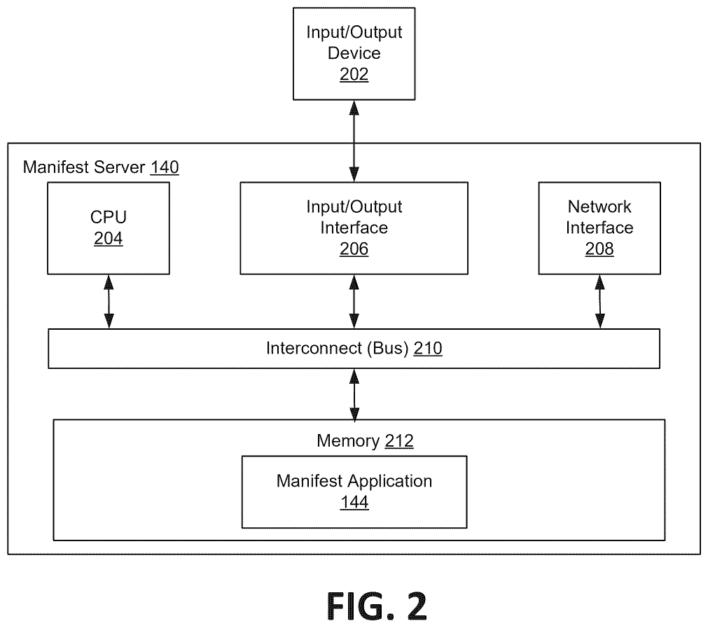

FIG. 2 is a more detailed illustration of manifest server 140 of FIG. 1, according to various embodiments. As shown, manifest server 140 includes, without limitation, a central processing unit (CPU) 204, an input/output (I/O) interface 206, a network interface 208, an interconnect (bus) 210, and a system memory 212.

CPU 204 is configured to retrieve and execute programming instructions, such as manifest application 144, stored in system memory 212. Similarly, CPU 204 is configured to store application data (e.g., software libraries) and retrieve application data from memory 212. Interconnect 210 is configured to facilitate transmission of data, such as programming instructions and application data, between CPU 204, I/O interface 206, network interface 208, and system memory 212. I/O interface 206 is configured to receive input data from I/O devices 202 and transmit the input data to CPU 204 via interconnect 210. For example, I/O devices 202 can include one or more buttons, a keyboard, a mouse, and/or other input devices. I/O interface 206 is further configured to receive output data from CPU 204 via interconnect 210 and transmit the output data to I/O devices 202.

A network interface 208 is configured to transmit and receive packets of data via a network (not shown). In some embodiments, network interface 208 is configured to communicate using the well-known Ethernet standard. Network interface 208 is coupled to CPU 204 via interconnect 210.

Memory 212 includes a manifest application 144. Manifest application 144 is a software application that is stored in memory of manifest server140 and executes on one or more processors (e.g., CPU 204) of manifest server 140. Manifest application 144 is configured to generate, for media content associated with a live streaming event, a manifest that specifies one or more video tracks, audio tracks, and/or timed text tracks. The manifest permits a client application (e.g., a client application running in one of user devices 114) to download and play back any portion of the media title in accordance with a combination of the tracks specified in the manifest. In some embodiments, one of the tracks specified by the manifest is a media events track associated with the same media content. In addition, the manifest includes a data structure specifying the media events indicating the start and end times of supplemental content that have occurred so far in the media content (up to the latest media event received by manifest server 140 from dynamic metadata server 108). For example, the data structure can indicate the media events up to a mediaEventsCutoffTime, which is the time (ms time) up to which the events have been received.

In some embodiments, live origin server 142 of FIG. 1 can be configured similarly to manifest server 140 appears in FIG. 2, except with a live origin application stored in a memory of live origin server 142 instead of manifest application 144 in memory 212. Although shown as distinct for illustrative purposes, in some embodiments, manifest server 140 and live origin server 142 can be combined into one server if, for example, the manifests served by manifest server 140 need to be updated with information stored at live origin server 142.

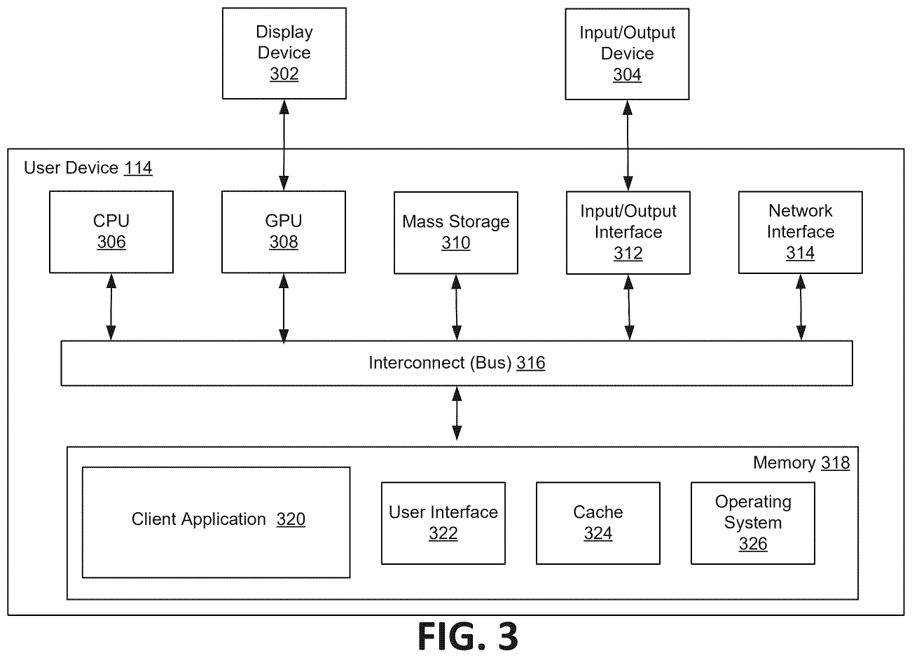

FIG. 3 is a more detailed illustration of one of user devices 114 of FIG. 1, according to various embodiments. As shown, a user device 114 can include, without limitation, a CPU 306, a graphics-processing unit (GPU) 308, an I/O interface 312, a mass storage unit 310, a network interface 314, an interconnect (bus) 316, and a memory 318.

In some embodiments, CPU 306 is configured to retrieve and execute programming instructions stored in memory 318. Similarly, CPU 306 is configured to store and retrieve application data (e.g., software libraries) residing in memory 318. Interconnect 316 is configured to facilitate transmission of data, such as programming instructions and application data, between CPU 306, GPU 308, I/O interface 312, mass storage 310, network interface 314, and memory 318.

In some embodiments, GPU 308 is configured to generate frames of video data and transmit the frames of video data to display device 302. In some embodiments, a hardware pipeline, independent of GPU 308, can perform video decoding and rendering to generate the frames of video data that are transmitted to display device 302. In some embodiments, GPU 308 can be integrated into an integrated circuit, along with CPU 306. Display device 302 can comprise any technically feasible means for generating an image for display. For example, display device 302 can be fabricated using liquid crystal display (LCD) technology, cathode-ray technology, and light-emitting diode (LED) display technology. An input/output (I/O) interface 312 is configured to receive input data from user I/O devices 304 and transmit the input data to CPU 306 via interconnect 316. For example, user I/O devices 304 can comprise one of more buttons, a keyboard, and a mouse or other pointing device. I/O interface 312 also includes an audio output unit configured to generate an electrical audio output signal. User I/O devices 304 includes a speaker configured to generate an acoustic output in response to the electrical audio output signal. In alternative embodiments, the display device 302 can include the speaker. A television is an example of a device known in the art that can display video frames and generate an acoustic output.

A mass storage unit 310, such as a hard disk drive or flash memory storage drive, is configured to store non-volatile data. A network interface 314 is configured to transmit and receive packets of data via a network (not shown). In some embodiments, network interface 314 is configured to communicate using the well-known Ethernet standard. Network interface 314 is coupled to CPU 306 via interconnect 316.

In some embodiments, memory 318 includes programming instructions and application data that comprise an operating system 326, a user interface 322, and a client application 320. Operating system 326 performs system management functions such as managing hardware devices including network interface 314, mass storage 310, I/O interface 312, and GPU 308. Operating system 326 also provides process and memory management models for user interface 322 and client application 320. User interface 322, such as a window and object metaphor, provides a mechanism for user interaction with user device 114. In some embodiments, during playback of a media content stream, user interface 322 can display supplemental content based on start and end times indicated by one or more media events. In some embodiments, while the supplemental content is being displayed, playback controls, other than pause, may not be available to the user via user interface 322. Persons skilled in the art will recognize the various operating systems and user interfaces that are well-known in the art and suitable for incorporation into user device 114.

In some embodiments, client application 320 is configured to request and receive content, such as media content associated with a live streaming event and a media events track, from live origin application 142, and client application 320 is configured to request and receive, from manifest server 140, a manifest that specifies, among other things, one or more media events that indicate the start and end times of supplemental content, via network interface 418. Further, client application 320 is configured to interpret the content and present the content via display device 302 and/or user I/O devices 304.

### Streaming Live Media Content with Events

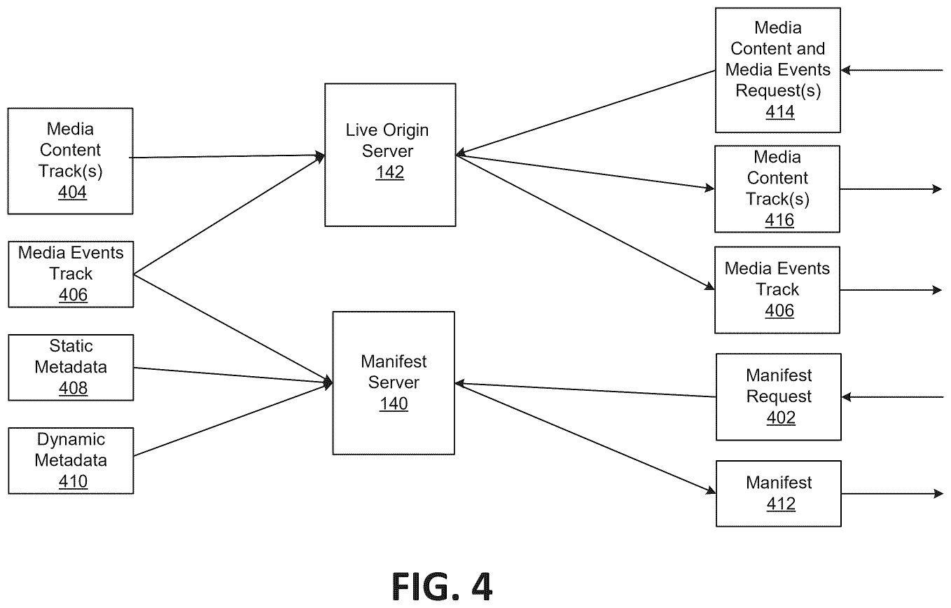

FIG. 4 is a more detailed illustration of live origin server 142 and manifest server 140 of FIG. 1, according to various embodiments. Illustratively, live origin server 142 and manifest server 140 are separate servers, but in some embodiments, live origin server 142 and manifest server 140 can be included together as a single server device.

Live origin server 142 is configured to receive and store various data associated with media content that live origin server 142 makes available. Illustratively, live origin server 142 receives, for media content associated with each live streaming event that live origin application 142 makes available, one or more media content tracks 404 and a media events track 406 from packager 106.

Media content track(s) 404 includes audio, video, and/or text streams for the media content. For example, media content track(s) 404 can include any number of video, audio, and text tracks that can be encoded differently, such as according to a bitrate ladder.

Media events track 406 is a track specifying media events for the media content of media content track(s) 404. Media events track 406 provides a real-time messaging channel for signaling media events, and in particular media events indicating the start and end times of supplemental content that occur subsequent to generation of the manifest, described above. Media events track 406 permits the streaming of such subsequent media events at the live edge independent of the playback position or even whether playback has started yet (e.g., if the manifest is prefetched). In some embodiments, the media events can include program boundary markers (e.g., splice points indicating the beginning and ending of supplemental content, such as advertisements, programs, chapters, interruptions, or extensions). In some embodiments, the media events can be specified in media events track 406 as described above in conjunction with FIG. 1.

Manifest server 140 is configured to receive a manifest request 402 and in response generate, for media content associated with a live streaming event, a manifest 412 that includes, among other things, a data structure specifying (1) the media events indicating the start and end times of supplemental content that have occurred so far in the media content based on dynamic metadata 410 (up to the latest media event received by manifest server 140 from dynamic metadata server 108), and (2) media events track 406.

Static metadata 408 is the static metadata for the media events associated with the media content associated with a live streaming event. Static metadata 408 is determined by static metadata server 116 in advance of the live stream and can include downloadable information associated with one or more tracks associated with the media content, such as a video, audio, text, and/or media event track. In some embodiments, static metadata for video and/or audio tracks can include additional information associated with bitrate, language, and other relevant information. In some embodiments, static metadata for media events tracks can include information that denotes the existence of the track.

Dynamic metadata 410 is the dynamic metadata for the media events corresponding to media content associated with a live streaming event. Dynamic metadata 410 can be determined when the live stream of the media content associated with a live streaming event begins and can include, for each media event, the availability start time, media presentation duration, presentation time offset, start segment number, segment URL templates, media timescale, and segment duration, each associated with supplemental content.

In operation, manifest application 144 can receive a request for a manifest associated with media content, shown as manifest request 402, from a client application of a user device (e.g., one of user devices 114). For example, manifest request 402 could be a request by the client application immediately before playing the media content that a user has selected, or a speculative request according to a pre-fetching technique prior to user selection of the media content. The manifest requested can be for any media content that is available, such as media content that is being live streamed in real-time when manifest request 402 is made, media content that was previously live streamed, or media content that is on-demand.

If manifest request 402 is for a manifest associated with media content that is being live streamed in real-time or was previously live streamed, manifest application144 generates manifest 412 using static metadata 408 and dynamic metadata 410. Manifest 412 is a file that specifies one or more video tracks, audio tracks, and/or timed text tracks, which permits a client application (e.g., a client application running in one of user devices 114) to download and play back any portion of the media title in accordance with a combination of the tracks specified in the manifest. In some embodiments, one of the tracks specified by manifest 412 is media events track 406 that is associated with the same media content, which can be specified in the same manner as video, audio, or timed text tracks in manifest 412, including using URLs and a segment template. In addition, manifest 412 includes a data structure specifying the media events indicating the start and end times of supplemental content that have occurred so far in the media content associated with a live streaming event (up to the latest media event described in dynamic metadata 410). The data structure of manifest 412 indicates the mediaEventsCutoffTime, which is the time (ms time) up to which the media events are provided. For example, if the media content is currently being live streamed and the media content request 402 was received by live origin application 142 at time T54.08, then the mediaEventsCutoffTime is equal to 54.08s. Furthermore, manifest 412 includes only the media events that occur prior to the mediaEventsCutoffTime. Alternatively, if the media content was previously live streamed, the mediaEventsCutoffTime would be equal to the duration of the media content associated with the live streaming event. Because such media content is no longer being live streamed, manifest 412 would include each media event for the media content. One or more media events described in manifest 412 each include a type and timestamp and optionally also include an identifier (ID) and a duration, as described in the Media Event record table above.

After manifest 412 is generated by manifest server 140, manifest application 144 transmits manifest 412 to the requesting client application. After receiving manifest 412, the client application can download a combination of video, audio, and/or text tracks, shown as media content track(s) 416, that are specified in manifest 412. For example, the client application can select media content track(s) 416 to download based on a current network condition. Illustratively, the client application has made one or more requests 414 for media content track(s) 416 and media events track 406, which as described above is also specified in manifest 412. Notably, the delivery of events in media events track 406 is decoupled from the streaming of media content, which can begin immediately after the client application has received manifest 412. Request(s) 414 for media content track(s) 412 can be forwarded to live origin application 142. In turn, live origin application 142 transmits media content track(s) 416 and media events track 406 to the client application. In some embodiments, live origin application 142 can also cache media content track(s) 416 and media events track 406 at CDN 146 to improve the speed at which media content track(s) 416 and media events track 406 are delivered in the future to client applications that make the same request.

Thereafter, the client application can play back media content track(s) 416 that are downloaded. In some embodiments, the client application can construct a playgraph, which is a graph of playback options, in order to control the playback. The client application can play back any supplemental content indicated by media events that are specified in manifest 412 and that occur prior to the mediaEventsCutoffTime. In addition, the client application can use media events track 406 to play back future supplemental content indicated by media events that occur after the mediaEventsCutoffTime. For example, if a user rewinds the media content while the media content is being live streamed, the client application can determine the placement (i.e., start and end times) for supplemental content based on a media event that occurs prior to mediaEventsCutoffTime and is specified in manifest 412. As another example, if the user plays back the media content to a time that is after mediaEventsCutoffTime, then the client application can determine the placement (i.e., start and end times) for supplemental content based on media events after mediaEventsCutoffTime that are specified in media events track 406. In some embodiments, the supplemental content associated with the media event is embedded into the media content stream. In some other embodiments, the client application can determine and retrieve the supplemental content based on URL(s) in the manifest.

Advantageously, use of manifest 412 and media events track 406 can result in less complexity at the client application, and streaming delays can also be avoided. The complexity reduction arises because client applications always have all the events (so far), permitting the client application to determine whether a given position in the stream is within the program or within supplement content, or not, without having to go to the network to find out. The play delay (and seek delay) reduction comes from not needing to request media event segments to discover the nature of a seek point before starting to retrieve media.

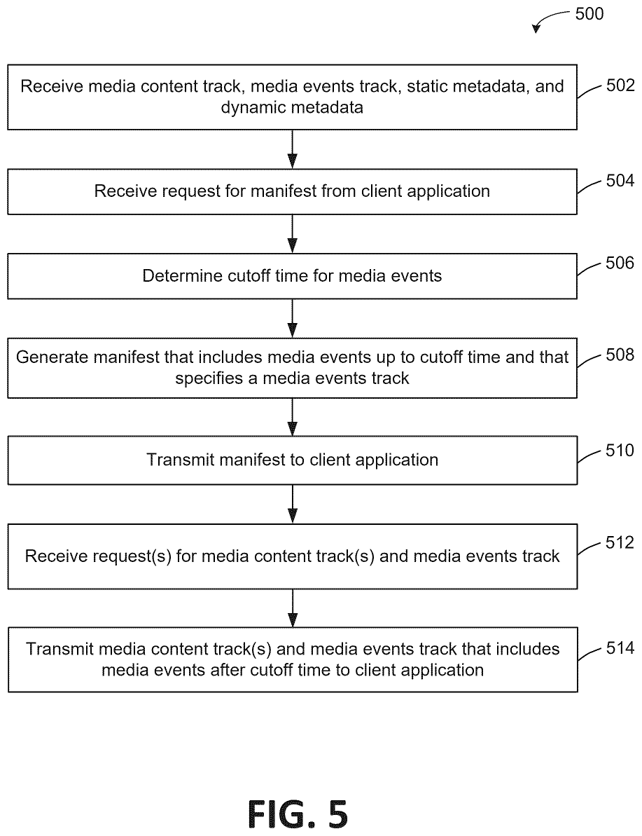

FIG. 5 is a flow diagram of method steps for delivering media events, according to various embodiments. Although the method steps are described in conjunction with the systems of FIG. 1-4, persons skilled in the art will understand that any system configured to perform the method steps in any order falls within the scope of the various embodiments.

As shown, a method 500 begins at step 502, where live origin server142 receives one or more media content tracks and a media events track from packager 106. In addition, manifest server 140 receives static metadata from static metadata server 116 and dynamic metadata from dynamic metadata server 108. Manifest server 140 can continue receiving static metadata and dynamic metadata for media events indicating supplemental content in media content associated with live streaming events that live origin server 142 makes available.

At step 504, manifest server 140 receives a request for a manifest associated with media content from a client application of a user device, such as client application 320 of user device 114. The request can be for a manifest associated with any media content that live origin application 142 is currently making available, such as media content that is currently being live streamed or media content that was previously live streamed. The request can be made by the client application immediately before playing media content that a user has selected, or the request can be made speculatively according to a pre-fetching technique prior to user selection of the media content.

At step 506, manifest application 144 of manifest server 140 determines a cutoff time, such as the mediaEventsCutoffTime, for media events pertaining to supplemental content in the media content for which the manifest is being requested. The cutoff time is the time up to which the media events are provided for the media content. For example, if the media content is currently being live streamed, the cutoff time corresponds to the timestamp in the live stream of the media content at which the manifest server 1402 received the manifest request. Alternatively, if the media content was previously live streamed, the cutoff time corresponds to the timestamp of the end of the media content.

At step 508, manifest application 144 generates a manifest that includes, among other things, information on each media event for the media content up to the determined cutoff time. As described, the manifest is a file that specifies one or more video tracks, audio tracks, and/or timed text tracks, which permits a client application (e.g., a client application running in one of user devices 114) to download and play back any portion of the media title in accordance with a combination of the tracks specified in the manifest. In some embodiments, the manifest also specifies a media events track associated with the same media content. In addition, the manifest includes a data structure specifying each media event for the media content up to the determined cutoff time. Manifest application 144 generates the manifest to include metadata from the static metadata and the dynamic metadata received by manifest server 140. Manifest application 144 can make available the generated manifest for delivery to the user device. In some embodiments, one or more media events described in the manifest each include a type and timestamp and optionally include an ID and duration.

At step 510, manifest application 144 transmits the manifest to the client application. In some embodiments, the manifest application 144 can make available the generated manifest to the user device and/or other user devices. At step 512, live origin application 142 receives one or more requests for one or more media content tracks and the media events track specified in the manifest. The request(s) can be forwarded to live origin application 142 by CDN steering server 152 within CDN 146 if one of CDN servers 148 have not cached the data being requested. If a CDN server within CDN servers 148 has cached the media content being requested, then the CDN steering server 152 can determine the proper CDN server within CDN servers 148 that has cached the requested media content.

At step 514, live origin application 142 (or a CDN server 148 that has cached the requested content) transmits, to the client application, the media content track(s) and media events track that are requested. The media events track includes media events after the cutoff time. The client application can use the media event information from the manifest and the media events track in any suitable manner. For example, the client application can download and play back supplement content, such as advertisement breaks, from a given starting time to a given ending time, that are indicated by the media events in the manifest and media events track. As another example, when the manifest includes media events for supplemental content, such as an advertisement break, but the media events track includes contradictory media events, such as changing a duration of the advertisement break (e.g., an Ad Break End event that includes an end time that differs from the end time signaled in an Ad Break event specified in the manifest) or canceling the advertisement break, the client application can change the duration of the advertisement break or cancel the advertisement break according to the media events track.

In sum, the disclosed techniques allow for live streaming of media content with media events. In some embodiments, a media content source sends (1) static metadata associated with media content, such as live streamed media content, and supplemental content embedded therein to a static metadata server; and (2) segments of the media content to an encoder. The encoder encodes the segments to generate encoded audio, video, and text streams, and the encoder further generates a media events track. The encoder sends the encoded segments of the media content and the media events track to a packager. The packager extracts dynamic metadata for each media event associated with the supplemental content embedded in the encoded segments and the media events track. The packager sends the dynamic metadata to a dynamic metadata server. The dynamic metadata server makes the events available to the manifest application. The manifest application generates a manifest based on the static metadata, the dynamic metadata, and the media events track. The manifest application server sends the manifest to a client application. The live origin application sends one or more media content streams, and the media events track to the client application. The media content stream(s) and the media events track can also be cached using one or more CDN servers. During playback of the media content based on the media content stream(s), the client application uses the manifest to determine media events and associated information regarding current and past supplemental content. In addition, the media events track is used to transmit, to the client application, media events associated with information on future supplemental content that are not specified in the manifest.

At least one technical advantage of the disclosed techniques relative to the prior art is that, with the disclosed techniques, media events can be accurately delivered without wasting network bandwidth and with built in scalability. In addition, by using a single manifest along with a media events track, the disclosed techniques do not require a client application to repeatedly download new/updated manifests to receive accurate media events regarding upcoming or past supplemental content. As a result, there is less complexity at the client applications, and streaming delays can also be avoided.
1. In some embodiments, a computer-implemented method for streaming media content with media events comprises receiving, at a first time, a request for a manifest associated with media content for a live streaming event, generating the manifest based on the request, wherein the manifest includes one or more first media events that occur prior to the first time, transmitting, to a client application, the manifest and the media content for playback, and transmitting, to the client application, a media events track that includes one or more second media events that occur subsequent to the first time.
2. The computer-implemented method of clause 1, wherein the one or more first media events and the one or more second media events include at least one of a program start event, a program end event, an advertisement break event, or an advertisement break early termination event.
3. The computer-implemented method of clauses 1 or 2, wherein the manifest includes information on one or more media content tracks and the media events track.
4. The computer-implemented method of any of clauses 1-3, further comprising transmitting, to the client application, the media content for the live streaming event, wherein the client application plays back the media content, supplemental content indicated by the one or more first media events, and supplemental content indicated by the one or more second media events.
5. The computer-implemented method of any of clauses 1-4, wherein the media events track is a moving picture experts group 4 part 14 (mp4) track.
6. The computer-implemented method of any of clauses 1-5, further comprising modifying at least one first media event included in the one or more first media events based on at least one second media event included in the one or more second media events.
7. The computer-implemented method of any of clauses 1-6, further comprising receiving metadata associated with the one or more first media events, wherein the manifest is further generated based on the metadata.
8. The computer-implemented method of any of clauses 1-7, further comprising receiving the media events track and one or more media content tracks, wherein each media content track included in the one or more media content tracks comprises an encoding of at least a portion of the media content.
9. The computer-implemented method of any of clauses 1-8, wherein the first time occurs during the live streaming event.
10. The computer-implemented method of any of clauses 1-9, wherein the one or more first media events indicate a start time and an end time for one or more first supplemental content, and wherein the one or more second media events indicate a start time and an end time for one or more second supplemental content.
11. In some embodiments, one or more non-transitory computer-readable media include instructions that, when executed by one or more processors, cause the one or more processors to perform the steps of receiving, at a first time, a request for a manifest associated with media content for a live streaming event, generating the manifest based on the request, wherein the manifest includes one or more first media events that occur prior to the first time, transmitting, to a client application, the manifest and the media content for playback, and transmitting, to the client application, a media events track that includes one or more second media events that occur subsequent to the first time.
12. The one or more non-transitory computer-readable media of clause 11, wherein the one or more first media events and the one or more second media events include at least one of a program start event, a program end event, an advertisement break event, or an advertisement break early termination event.
13. The one or more non-transitory computer-readable media of clauses 11 or 12, wherein the manifest includes information about one or more media content tracks and the media events track.
14. The one or more non-transitory computer-readable media of any of clauses 11-13, wherein the instructions, when executed by one or more processors, further cause the one or more processors to perform the step of transmitting, to the client application, the media content for the live streaming event, wherein the client application plays back the media content, one or more supplemental content indicated by the one or more first media events, and one or more supplemental content indicated by the one or more second media events.
15. The one or more non-transitory computer-readable media of any of clauses 11-14, wherein the media events track is a moving picture experts group 4 part 14 (mp4) track.
16. The one or more non-transitory computer-readable media of any of clauses 11-15, wherein the instructions, when executed by one or more processors, further cause the one or more processors to perform the step of modifying at least one first media event included in the one or more first media events based on at least one second media event included in the one or more second media events.
17. The one or more non-transitory computer-readable media of any of clauses 11-16, wherein the one or more first media events indicate a start time and an end time for one or more first supplemental content, and wherein the one or more second media events indicate a start time and an end time for one or more second supplemental content.
18. The one or more non-transitory computer-readable media of any of clauses 11-17, wherein the step of transmitting, to the client application, the manifest and the media content for playback further comprises transmitting, to the client application, one or more media content tracks, wherein the one or more media content tracks include at least one portion of the media content for playback.
19. The one or more non-transitory computer-readable media of any of clauses 11-18, wherein the instructions, when executed by one or more processors, further cause the one or more processors to perform the step of receiving the media events track from a packager.
20. In some embodiments, a system comprises one or more memories storing instructions, and one or more processors coupled to the one or more memories that, when executing the instructions, perform the steps of receiving, at a first time, a request for a manifest associated with media content for a live streaming event, generating the manifest based on the request, wherein the manifest includes one or more first media events that occur prior to the first time, transmitting, to a client application, the manifest and the media content for playback, and transmitting, to the client application, a media events track that includes one or more second media events that occur subsequent to the first time.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for streaming media content with media events, the method comprising:
receiving, at a first time, a request for a manifest associated with media content for a live streaming event;
generating the manifest based on the request, wherein the manifest includes one or more first media events that occur prior to the first time;
transmitting, to a client application, the manifest and the media content for playback; and
transmitting, to the client application, a media events track that includes one or more second media events that occur subsequent to the first time.

2. The computer-implemented method of claim 1, wherein the one or more first media events and the one or more second media events include at least one of:
a program start event;
a program end event;
an advertisement break event; or
an advertisement break early termination event.

3. The computer-implemented method of claim 1, wherein the manifest includes information on one or more media content tracks and the media events track.

4. The computer-implemented method of claim 1, further comprising transmitting, to the client application, the media content for the live streaming event, wherein the client application plays back the media content, supplemental content indicated by the one or more first media events, and supplemental content indicated by the one or more second media events.

5. The computer-implemented method of claim 1, wherein the media events track is a moving picture experts group 4 part 14 (mp4) track.

6. The computer-implemented method of claim 1, further comprising modifying at least one first media event included in the one or more first media events based on at least one second media event included in the one or more second media events.

7. The computer-implemented method of claim 1, further comprising receiving metadata associated with the one or more first media events, wherein the manifest is further generated based on the metadata.

8. The computer-implemented method of claim 1, further comprising receiving the media events track and one or more media content tracks, wherein each media content track included in the one or more media content tracks comprises an encoding of at least a portion of the media content.

9. The computer-implemented method of claim 1, wherein the first time occurs during the live streaming event.

10. The computer-implemented method of claim 1, wherein the one or more first media events indicate a start time and an end time for one or more first supplemental content, and wherein the one or more second media events indicate a start time and an end time for one or more second supplemental content.

11. One or more non-transitory computer-readable media including instructions that, when executed by one or more processors, cause the one or more processors to perform the steps of:
receiving, at a first time, a request for a manifest associated with media content for a live streaming event;
generating the manifest based on the request, wherein the manifest includes one or more first media events that occur prior to the first time;
transmitting, to a client application, the manifest and the media content for playback; and
transmitting, to the client application, a media events track that includes one or more second media events that occur subsequent to the first time.

12. The one or more non-transitory computer-readable media of claim 11, wherein the one or more first media events and the one or more second media events include at least one of:
a program start event;
a program end event;
an advertisement break event; or
an advertisement break early termination event.

13. The one or more non-transitory computer-readable media of claim 11, wherein the manifest includes information about one or more media content tracks and the media events track.

14. The one or more non-transitory computer-readable media of claim 11, wherein the instructions, when executed by one or more processors, further cause the one or more processors to perform the step of transmitting, to the client application, the media content for the live streaming event, wherein the client application plays back the media content, one or more supplemental content indicated by the one or more first media events, and one or more supplemental content indicated by the one or more second media events.

15. The one or more non-transitory computer-readable media of claim 11, wherein the media events track is a moving picture experts group 4 part 14 (mp4) track.

16. The one or more non-transitory computer-readable media of claim 11, wherein the instructions, when executed by one or more processors, further cause the one or more processors to perform the step of modifying at least one first media event included in the one or more first media events based on at least one second media event included in the one or more second media events.

17. The one or more non-transitory computer-readable media of claim 11, wherein the one or more first media events indicate a start time and an end time for one or more first supplemental content, and wherein the one or more second media events indicate a start time and an end time for one or more second supplemental content.

18. The one or more non-transitory computer-readable media of claim 11, wherein the step of transmitting, to the client application, the manifest and the media content for playback further comprises transmitting, to the client application, one or more media content tracks, wherein the one or more media content tracks include at least one portion of the media content for playback.

19. The one or more non-transitory computer-readable media of claim 11, wherein the instructions, when executed by one or more processors, further cause the one or more processors to perform the step of receiving the media events track from a packager.

20. A system comprising:
one or more memories storing instructions; and
one or more processors coupled to the one or more memories that, when executing the instructions, perform the steps of:
receiving, at a first time, a request for a manifest associated with media content for a live streaming event,
generating the manifest based on the request, wherein the manifest includes one or more first media events that occur prior to the first time,
transmitting, to a client application, the manifest and the media content for playback, and
transmitting, to the client application, a media events track that includes one or more second media events that occur subsequent to the first time.
